(19) United States
(12) Patent Application Publication
(10) Pub. No.: US 2023/0177518 A1
(43) Pub. Date: Jun. 8, 2023

(54) ENHANCED ISSUE DETECTION AND RESOLUTION IN A CALL CENTER

(71) Applicant: International Business Machines Corporation, Armonk, NY (US)

(72) Inventors: Clement Decrop, Arlington, VA (US); Tiberiu Suto, Franklin, NY (US); Kelly Camus, Durham, NC (US); Zachary A. Silverstein, Georgetown, TX (US)

(21) Appl. No.: 17/457,743

(22) Filed: Dec. 6, 2021

(51) Int. Cl. G06Q 30/00; H04M 3/51

(52) U.S. Cl. CPC G06Q 30/016; H04M 3/5166

(57) ABSTRACT

In an approach for proactively detecting and resolving an issue of a plurality of active callers placed in a call queue using a machine learning technique, a processor monitors a call queue. A processor determines that a first threshold is triggered when a pre-set percentage of active callers are placed in the call queue. A processor analyzes a set of information in a customer account of each active caller for one or more common factors. A processor identifies a reason for the event occurring from the one or more common factors. A processor registers the event occurring as the domain event. A processor resolves the event occurring by providing the plurality of active callers with a resolution. A processor determines if a second threshold is triggered. Responsive to determining the second threshold is triggered, a processor executes an Interactive Voice Response workflow.

### BACKGROUND OF THE INVENTION

The present invention relates generally to the field of data processing, and more particularly to enhanced issue detection and resolution in a call center.

A call queue is a phone system feature used by businesses to organize and distribute inbound phone calls into a virtual line (i.e., a virtual queue) based on pre-established criteria. The inbound phone calls are placed on hold until a customer service representative can assist the caller. The purpose of a call queue is to cut down on hold times, call transfers, and the number of phone calls needed to resolve an issue. The call queue accomplishes this purpose by evaluating the caller's Interactive Voice Response (IVR) input, by following preset call routing rules and by providing helpful information while customers wait for a customer service representative. IVR is a Voice over Internet Protocol (VoIP) technology that allows the caller to interact with a prerecorded phone menu. IVR works alongside an automatic call distribution system to collect the most important caller information and to determine the most likely reason for the call. IVR learns what a caller needs through the caller's verbal responses or manual telephone keypad entries to a list of prerecorded and automatically played messages and menu options. Manual keypad entries are processed through Dual-Tone Multi-Frequency signals, which are created when the caller's touch-tone keypad selections interact with the phone system, triggering intelligent call routing. IVR evaluates verbal responses through Natural Language Processing (NLP), which is a type of conversational artificial intelligence equipped with speech recognition capabilities. IVR can pick up keywords, sentences, and phrases that trigger pre-determined actions. IVR then routes the caller to the proper customer service representative or provides the caller with information based on the caller's dial pad selections or voice responses.

To discover, validate, and optimize business processes, a technique referred to as process mining is used. A business mines event log data from the business's databases, information systems, or business management software such as enterprise resource planning, customer relationship management, electronic health records, etc. using data mining algorithms.

Event log data is created when callers interact with the business's IT systems. The caller's actions are captured by these systems and a digital record is created. Examples of such actions are receiving an order, submitting a piece of documentation, approving a loan, entering information into a health record, etc. Process mining software then transforms the digital records into event logs. Event logs have at least three main attributes: a case ID, an activity, and a timestamp.

With the event logs, process mining can create an end-to-end visualization of the business process flow. Process mining examines the business process flow and outlines the details of it along with any variations of the business process flow through process analytics. As process analytics takes place, customized Key Performance Indicators are created and monitored to uncover potential improvement areas, data mining and/or machine learning algorithms are used to detect hidden patterns and dependencies; and conformance checking techniques are applied to compare the process to a certain ideal model.

### SUMMARY

Aspects of an embodiment of the present invention disclose a method, computer program product, and computer system for proactively detecting and resolving an issue of a plurality of active callers placed in a call queue using a machine learning technique. Responsive to an event occurring that impacts a plurality of customers of a user and causes the plurality of customers to call the user for assistance, a processor determines if there is a domain event registered for the event occurring. Responsive to determining the domain event is not registered for the event occurring, A processor monitors a call queue of the plurality of customers calling the user. A processor determines that a first threshold is triggered, wherein the first threshold is triggered when a pre-set percentage of active callers are placed in the call queue. A processor analyzes a set of information in a customer account of each active caller placed in the call queue for one or more common factors. A processor identifies a reason for the event occurring from the one or more common factors. A processor registers the event occurring as the domain event. A processor processes a call for each active caller placed in the call queue using an artificial intelligence method. A processor resolves the event occurring by providing the plurality of customers calling the user with a resolution. A processor determines if a second threshold is triggered, wherein the second threshold is triggered when a pre-set percentage of active callers accepting the resolution. Responsive to determining the second threshold is triggered, a processor executes an Interactive Voice Response (IVR) workflow.

In some aspects of an embodiment of the present invention, prior to determining if the domain event is registered for the event occurring, a processor identifies each active caller placed in the call queue, wherein each active caller placed in the call queue is identified by doing a reverse search of a phone number from which each active caller in the call queue called.

In some aspects of an embodiment of the present invention, subsequent to executing the IVR workflow, a processor requests feedback on the IVR workflow from the user. A processor receives the feedback on the IVR workflow from the user. A processor gauges a level of relevancy of the feedback on the IVR workflow. A processor applies the feedback on the IVR workflow.

In some aspects of an embodiment of the present invention, responsive to determining the domain event is registered for the event occurring, a processor analyzes the set of information in the customer account of each active caller placed in the call queue for the one or more common factors. A processor creates one or more clusters that are each representative of the one or more common factors. A processor segments the active callers in the call queue into the one or more clusters.

In some aspects of an embodiment of the present invention, a processor extracts a service response via Natural Language Processing. A processor extracts a service response via Natural Language Classifier. A processor extracts a service response via Natural Language Understanding.

In some aspects of an embodiment of the present invention, a processor analyzes one or more resolutions provided manually to one or more previous callers by one or more customer service representatives for an issue identical to or nearly identical to the event occurring. A processor identifies one or more key words in the one or more resolutions provided manually to the one or more previous callers. A processor extracts the one or more key words and one or more words associated with the one or more key words from the one or more resolutions provided manually to the one or more previous callers. A processor modifies dynamically an IVR system to incorporate a learned response, wherein the learned response is the one or more resolutions provided manually to the one or more previous callers.

In some aspects of an embodiment of the present invention, a processor pre-generates the IVR workflow based on the learned response. A processor generates a synthesized voice message customized for each active caller placed in the call queue acknowledging the event occurring and offering the resolution. A processor plays the synthesized voice message for each active caller placed in the call queue. A processor enables each active caller placed in the call queue to accept the resolution.

In some aspects of an embodiment of the present invention, the second threshold is pre-set to one or more priority levels based on a level of urgency of the event occurring.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a block diagram illustrating a distributed data processing environment, in accordance with an embodiment of the present invention;

FIG. 2 is a flowchart illustrating the operational steps for a setup component of an issue detection and resolution program, on a server within the distributed data processing environment of FIG. 1, in accordance with an embodiment of the present invention;

FIG. 3 is a flowchart illustrating the operational steps of the issue detection and resolution program, on the server within the distributed data processing environment of FIG. 1, in accordance with an embodiment of the present invention; and

FIG. 4 is a block diagram illustrating the components of a computing device within the distributed data processing environment of FIG. 1, in accordance with an embodiment of the present invention.

### DETAILED DESCRIPTION

Embodiments of the present invention recognize that, when there is a statistically significant increase in the number of calls to a business, the effects are far-reaching. From longer wait times to dropping customer satisfaction rates, high call volumes pose a significant challenge to the business's call center. Therefore, embodiments of the present invention recognize the need for an improvement over technologies found in the marketplace today meant to handle high call volumes.

Embodiments of the present invention provide a system and method to find a commonality between a plurality of active callers in a call queue by analyzing the customer account information of the plurality of active callers and by detecting a statistically significant differential between the makeup of the plurality of active callers in the call queue to the makeup of all possible callers. Embodiments of the present invention provide a system and method to cluster the plurality of active callers in the call queue based on the commonality found. Embodiments of the present invention provide a system and method to proactively detect a cluster of active callers' issue and to pre-generate a workflow for an IVR system based on the cluster of active callers' issue using contextual analysis, natural language processing (NLP), a Natural Language Classifier (NLC), natural language understanding (NLU), and audio processing of calls. Embodiments of the present invention provide a system and method to execute the workflow for the IVR system when a dynamically set number or percentage of active callers accept the resolution triggering a threshold decision.

Implementation of embodiments of the present invention may take a variety of forms, and exemplary implementation details are discussed subsequently with reference to the Figures.

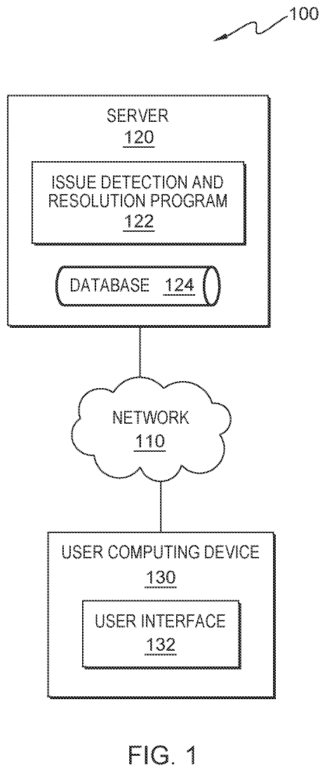

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, IoT sensors, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, and other computing devices (not shown) within distributed data processing environment 100.

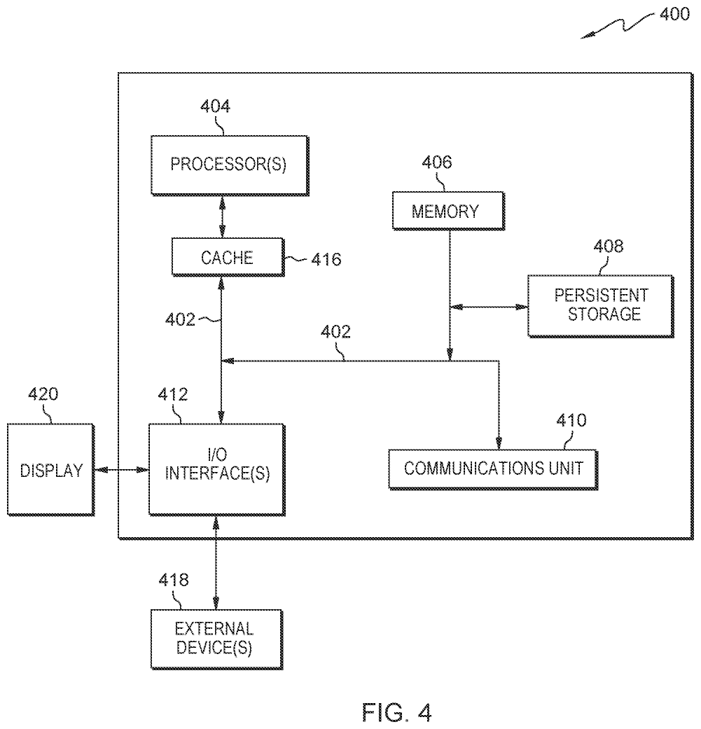

Server 120 operates to run issue detection and resolution program 122 and to send and/or store data in database 124. In an embodiment, server 120 can send data from database 124 to user computing device 130. In an embodiment, server 120 can receive data in database 124 from user computing device 130. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 4.

Issue detection and resolution program 122 operates to find a commonality between a plurality of active callers in a call queue by analyzing the customer account information of the plurality of active callers and by detecting a statistically significant differential between the makeup of the plurality of active callers in the call queue to the makeup of all possible callers. Issue detection and resolution program 122 operates to cluster the plurality of active callers in the call queue based on the commonality found. Issue detection and resolution program 122 operates to proactively detect a cluster of active callers' issue and to pre-generate a workflow for an IVR system based on the cluster of active callers' issue using contextual analysis, NLP, a NLC, NLU, and audio processing of calls. Issue detection and resolution program 122 operates to execute the workflow for the IVR system when a dynamically set number or percentage of active callers accept the resolution triggering a threshold decision. In the depicted embodiment, issue detection and resolution program 122 is a standalone program. In another embodiment, issue detection and resolution program 122 may be integrated into another software product, such as a call center software. In the depicted embodiment, issue detection and resolution program 122 resides on server 120. In another embodiment, issue detection and resolution program 122 may reside on user computing device 130 or on another computing device (not shown), provided that issue detection and resolution program 122 has access to network 110.

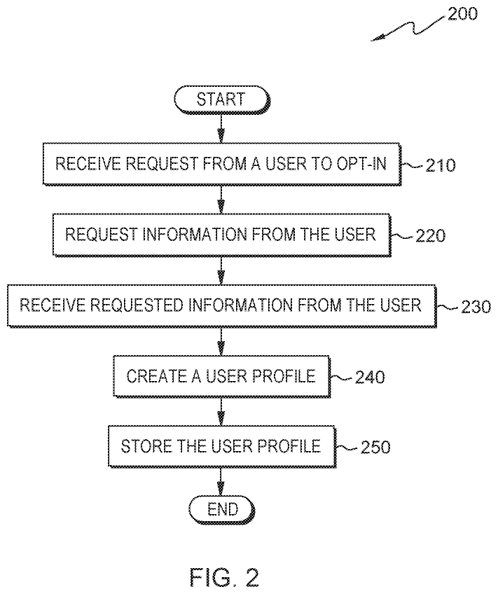

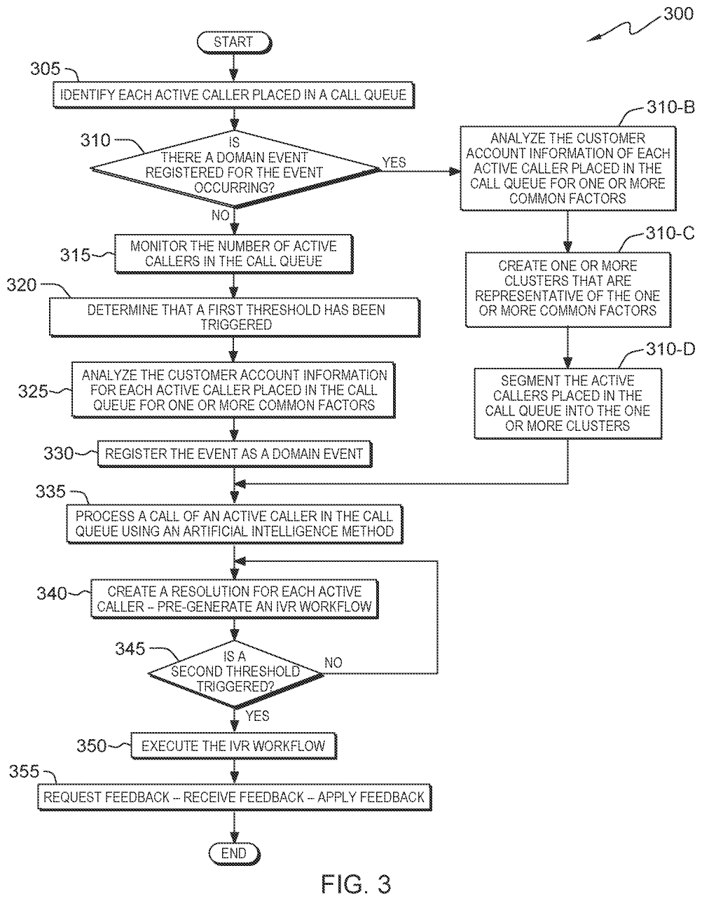

In an embodiment, the user of user computing device 130 registers with server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via issue detection and resolution program 122). Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124. The setup component of issue detection and resolution program 122 is depicted and described in further detail with respect to FIG. 2. The operational steps of issue detection and resolution program 122 are depicted and described in further detail with respect to FIG. 3.

Database 124 operates as a repository for data received, used, and/or generated by issue detection and resolution program 122. A database is an organized collection of data. Data includes, but is not limited to, information about user preferences (e.g., general user system settings such as alert notifications for user computing device 130); information about alert notification preferences; customer account information; previous customer service resolutions; key words of the previous customer service resolutions; any words associated with the key words of the previous customer service resolutions; the IVR workflow; and any other data received, used, and/or generated by issue detection and resolution program 122.

Database 124 can be implemented with any type of device capable of storing data and configuration files that can be accessed and utilized by server 120, such as a hard disk drive, a database server, or a flash memory. In an embodiment, database 124 is accessed by issue detection and resolution program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that issue detection and resolution program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Issue detection and resolution program 122 enables the authorized and secure processing of personal data.

Issue detection and resolution program 122 provides informed consent, with notice of the collection of personal and/or confidential data, allowing the user to opt-in or opt-out of processing personal and/or confidential data. Consent can take several forms. Opt-in consent can impose on the user to take an affirmative action before personal and/or confidential data is processed. Alternatively, opt-out consent can impose on the user to take an affirmative action to prevent the processing of personal and/or confidential data before personal and/or confidential data is processed. Issue detection and resolution program 122 provides information regarding personal and/or confidential data and the nature (e.g., type, scope, purpose, duration, etc.) of the processing. Issue detection and resolution program 122 provides the user with copies of stored personal and/or confidential company data. Issue detection and resolution program 122 allows the correction or completion of incorrect or incomplete personal and/or confidential data. Issue detection and resolution program 122 allows for the immediate deletion of personal and/or confidential data.

User computing device 130 operates to run user interface 132 through which a user can interact with issue detection and resolution program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with issue detection and resolution program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132. User computing device 130 may include components as described in further detail in FIG. 4.

User interface 132 operates as a local user interface between issue detection and resolution program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from issue detection and resolution program 122 to a user via network 110. User interface 132 can also display or present alerts including information (such as graphics, text, and/or sound) sent from issue detection and resolution program 122 to a user via network 110. In an embodiment, user interface 132 is capable of sending and receiving data (i.e., to and from issue detection and resolution program 122 via network 110, respectively). Through user interface 132, a user can opt-in to issue detection and resolution program 122; create a user profile; and set user preferences and alert notification preferences.

A user preference is a setting that can be customized for a particular user. A set of default user preferences are assigned to each user of issue detection and resolution program 122. A user preference editor can be used to update values to change the default user preferences. User preferences that can be customized include, but are not limited to, general user system settings, specific user profile settings, alert notification settings, and machine-learned data collection/storage settings.

Machine-learned data is a user's personalized corpus of data. Machine-learned data includes, but is not limited to, data regarding previous domain events and profiled domains of active callers; past results of iterations of issue detection and resolution program 122 (e.g., the resolutions created and the IVR workflows pre-generated in response to the resolutions being created); and an active caller's previous response to an iteration of issue detection and resolution program 122 (e.g., whether an active caller accepted a resolution).

Issue detection and resolution program 122 self-learns by tracking user activity, by classifying and retaining new content, and by improving with each iteration of issue detection and resolution program 122. Issue detection and resolution program 122 tracks which Interactive Voice Response (IVR) workflow or portion of an IVR workflow is repeatedly generated. By tracking such data, issue detection and resolution program 122 can learn which IVR workflow is relevant to the user (e.g., repeatedly generating an IVR workflow or a portion of an IVR workflow) and which IVR workflow is irrelevant (e.g., repeatedly removing a certain IVR workflow or a portion of a certain IVR workflow).

Issue detection and resolution program 122 classifies IVR workflows and portions of IVR workflows based on the likelihood a user will generate an IVR workflow or a portion of an IVR workflow. In an embodiment, issue detection and resolution program 122 classifies an IVR workflow or a portion of an IVR workflow on a scale, e.g., of 1 (i.e., a low chance the IVR workflow or the portion of the IVR workflow will be generated) to 10 (i.e., a high chance the IVR workflow or the portion of the IVR workflow will be generated). By classifying and retaining such data, issue detection and resolution program 122 can automatically filter out certain IVR workflows over time and ensure that repetitive information is not generated and sent to the user. Instead, issue detection and resolution program 122 bypasses the repetitive information and locates new information for the user. Issue detection and resolution program 122 can also recommend suggestions (e.g., on the likelihood of generation of certain IVR workflows) to the user so that the user can manually filter out certain IVR workflows.

FIG. 2 is a flowchart, generally designated 200, illustrating the operational steps for a setup component of issue detection and resolution program 122 on server 120 in distributed data processing environment 100, such as the one depicted in FIG. 1, in accordance with an embodiment of the present invention. In an embodiment, issue detection and resolution program 122 completes a one-time setup with a user. The one-time setup allows for issue detection and resolution program 122 to capture relevant information about the user to create a user profile. In an embodiment, issue detection and resolution program 122 receives a request from the user to opt-in. In an embodiment, issue detection and resolution program 122 requests information from the user. In an embodiment, issue detection and resolution program 122 receives the requested information from the user. In an embodiment, issue detection and resolution program 122 creates a user profile (i.e., a personalized corpus of data). In an embodiment, issue detection and resolution program 122 stores the user profile (i.e., the personalized corpus of data). It should be appreciated that the process depicted in FIG. 2 illustrates one possible iteration of issue detection and resolution program 122, which may be repeated for each opt-in request received by issue detection and resolution program 122.

In step 210, issue detection and resolution program 122 receives a request from a user to opt-in. A user may include, but is not limited to, a business that uses a call center to handle inbound and outbound customer interactions (e.g., doctor's office, medical or dental clinic, pharmacy, legal services provider, financial advisor, e-commerce company, delivery company, transportation company, airline company, IT company, home services provider (i.e., plumber, electrician, etc.)). In an embodiment, issue detection and resolution program 122 receives a request from a user to opt-in to issue detection and resolution program 122. In an embodiment, issue detection and resolution program 122 receives a request from a user to opt-in to issue detection and resolution program 122 through user interface 132 of user computing device 130. By opting-in, the user agrees to share data with database 124.

In step 220, issue detection and resolution program 122 requests information from the user. In an embodiment, responsive to receiving a request from a user to opt-in, issue detection and resolution program 122 requests information from the user. In an embodiment, issue detection and resolution program 122 requests information from the user to create a user profile. In an embodiment, issue detection and resolution program 122 requests information from the user through user interface 132 of user computing device 130. Information requested from the user includes, but is not limited to, information about user preferences (e.g., general user system settings such as alert notifications for user computing device 130); information about alert notification preferences (e.g., alert notification preview, alert notification style (i.e., alert notification appearing on lock screen, notification center, and/or banner; alert notification appearing temporary or persistently; alert notification sound on or off; alert notification grouping automatically, by application, or off), and alert notification frequency); information about the business of the user (e.g., form of business ownership, management of the business, scope and size of the business, industry classification, activities (i.e., accounting, finance, manufacturing, marketing, research and development, safety, sales)); and information about the customers of the user (i.e., customer account information (e.g., name of the customer, phone number of the customer, billing/shipping address of the customer, and previous purchases of the customer)).

In step 230, issue detection and resolution program 122 receives the requested information from the user. In an embodiment, responsive to requesting information from the user, issue detection and resolution program 122 receives the requested information from the user. In an embodiment, issue detection and resolution program 122 receives the requested information from the user through user interface 132 of user computing device 130.

In step 240, issue detection and resolution program 122 creates a user profile. In an embodiment, responsive to receiving the requested information from the user, issue detection and resolution program 122 creates a user profile. In an embodiment, issue detection and resolution program 122 creates a user profile for the user. In an embodiment, issue detection and resolution program 122 creates a user profile with information input by the user during setup regarding the user (i.e., information necessary to create a user profile) as well as user preferences and alert notification preferences.

In step 250, issue detection and resolution program 122 stores the user profile. In an embodiment, responsive to creating a user profile, issue detection and resolution program 122 stores the user profile. In an embodiment, issue detection and resolution program 122 stores the user profile in a database, e.g., database 124.

FIG. 3 is a flowchart, generally designated 300, illustrating the operational steps of issue detection and resolution program 122, on server 120 within distributed data processing environment 100 of FIG. 1, in accordance with an embodiment of the present invention. In an embodiment, issue detection and resolution program 122 operates to find a commonality between a plurality of active callers in a call queue by analyzing the customer account information of the plurality of active callers and by detecting a statistically significant differential between the makeup of the plurality of active callers in the call queue to the makeup of all possible callers. Issue detection and resolution program 122 operates to cluster the plurality of active callers in the call queue based on the commonality found. Issue detection and resolution program 122 operates to proactively detect a cluster of active callers' issue and to pre-generate a workflow for an IVR system based on the cluster of active callers' issue using contextual analysis, NLP, a NLC, NLU, and audio processing of calls. Issue detection and resolution program 122 operates to execute the workflow for the IVR system when a dynamically set number or percentage of active callers accept the resolution triggering a threshold decision. It should be appreciated that the process depicted in FIG. 3 illustrates one possible iteration of the process flow, which may be repeated each time the call center that handles the inbound and outbound customer interactions has a statistically significant change in the number of active callers in the call queue because of a domain event.

In step 305, issue detection and resolution program 122 identifies each active caller placed in a call queue. In an embodiment, issue detection and resolution program 122 completes a reverse search of the phone number of each active caller placed in the call queue. In an embodiment, issue detection and resolution program 122 matches the phone number obtained from the reverse search to customer account information stored in a database, e.g., database 124. In an embodiment, issue detection and resolution program 122 retrieves the customer account information of each active caller placed in the call queue from the database, e.g., database 124.

In decision 310, issue detection and resolution program 122 determines if there is a domain event registered for the event occurring. In an embodiment, responsive to identifying each active caller placed in the call queue, issue detection and resolution program 122 determines if there is a domain event registered for the event occurring. A domain event is an event that impacts a plurality of customers of the user and causes the plurality of customers to call the user for assistance. If issue detection and resolution program 122 determines there is a domain event registered for the event occurring (decision 310, YES branch), then issue detection and resolution program 122 proceeds to step 310-B, analyzing the customer account information of each active caller placed in the call queue for one or more common factors. If issue detection and resolution program 122 determines there is no domain event registered for the event occurring (decision 310, NO branch), then issue detection and resolution program 122 proceeds to step 315, monitoring the number of active callers placed in the call queue.

In a first example, issue detection and resolution program 122 determines that because of severe weather occurring in the Northeast area of the United States, Delivery Company A expected staffing fluctuations and knew that the staffing fluctuations would cause the delivery of overnight packages to be delayed. Delivery Company A registered the severe weather as a domain event that would impact a plurality of customers of Delivery Company A, causing the plurality of customers to call Delivery Company A for assistance.

In a second example, issue detection and resolution program 122 determines that Airline Company D did not register severe weather occurring in the Southeast area of the United States as an event that would impact a plurality of customers from the Southwest of the United States.

In step 310-B, issue detection and resolution program 122 analyzes the customer account information of each active caller placed in the call queue for one or more common factors. In an embodiment, responsive to determining there is a domain event registered for the event occurring, issue detection and resolution program 122 analyzes the customer account information of each active caller placed in the call queue for one or more common factors (e.g., a geographical location from where the active caller is calling the user, a service of the user subscribed to by the active caller, a previous purchase of the active caller, and whether the active caller represents a business or is a consumer). In an embodiment, issue detection and resolution program 122 compares the overall makeup of the active callers placed in the call queue to the overall makeup of all the customers of the user. In an embodiment, issue detection and resolution program 122 compares the overall makeup of the active callers placed in the call queue to the overall makeup of all the customers of the user in order to determine the statistical significance of the one or more common factors (i.e., to determine whether the one or more common factors is likely due to chance or due to some factor of interest).

Continuing the first example from above, issue detection and resolution program 122 analyzes the customer account information for the active callers in the call queue and finds a common factor. A majority of the active callers in the call queue of Delivery Company A used Delivery Company A to deliver packages overnight. The packages were supposed to be delivered by 10:30 A.M. that morning. The packages were not delivered. Issue detection and resolution program 122 recognizes the use of Delivery Company A to deliver packages overnight as the common factor between the active callers in the call queue.

In step 310-C, issue detection and resolution program 122 creates one or more clusters. In an embodiment, responsive to analyzing the customer account information of each active caller placed in the call queue for one or more common factors, issue detection and resolution program 122 creates one or more clusters. In an embodiment, issue detection and resolution program 122 creates one or more clusters that are each representative of the one or more common factors. In an embodiment, issue detection and resolution program 122 ranks the clusters in the order of statistical significance of the common factor when there is more than one cluster created.

Continuing the first example from above, issue detection and resolution program 122 creates one or more clusters that are each representative of the one or more common factors (i.e., the geographical location from where the active callers are calling the user and whether the active callers did or did not do business with the user recently). Issue detection and resolution program 122 creates a cluster for the Northeast geographical area of the United States and a cluster for the other geographical areas of the United States (i.e., Southwest, West, Southeast, and Midwest). Issue detection and resolution program 122 creates a cluster for users who used Delivery Company A to deliver packages overnight and a cluster for users who did not use Delivery Company A to deliver packages overnight. Issue detection and resolution program 122 ranks the two clusters in the order of the statistical significance of the factor the cluster represents.

In step 310-D, issue detection and resolution program 122 segments the active callers placed in the call queue into the one or more clusters. In an embodiment, responsive to creating one or more clusters, issue detection and resolution program 122 segments the active callers placed in the call queue into the one or more clusters.

Continuing the first example from above, issue detection and resolution program 122 segments the active callers in the call queue from the Northeast into one cluster. Issue detection and resolution segments the active callers in the call queue who used Delivery Company A to deliver packages overnight, were supposed to be delivered by 10:30 A.M. that morning, and were not delivered into another cluster. Issue detection and resolution program 122 ranks the two clusters in the order of the statistical significance of the factor the cluster represents.

In step 315, issue detection and resolution program 122 monitors the number of active callers placed in the call queue. In an embodiment, responsive to determining there is no domain event registered for the event occurring, issue detection and resolution program 122 monitors the number of active callers placed in the call queue.

In step 320, issue detection and resolution program 122 determines that a first threshold has been triggered. In an embodiment, responsive to monitoring the number of active callers placed in the call queue, issue detection and resolution program 122 determines that a first threshold has been triggered. The first threshold is triggered when a pre-set number or a pre-set percentage of a profiled domain of active callers are placed in the call queue. A profiled domain of active callers is a subgroup of active callers who share one or more common factors and who are distinguished from all possible callers of the user because of the one or more common factors. Prior to the first threshold being triggered, issue detection and resolution program 122 routes the active caller's phone call to a customer service representative to be resolved.

Continuing the second example from above, the call queue has ten inbound calls. A customer service representative handles the first ten inbound calls. As issue detection and resolution program 122 is monitoring the call queue, issue detection and resolution program 122 determines that the first threshold has been triggered when the call queue jumps from ten inbound calls to one hundred inbound calls.

In step 325, issue detection and resolution program 122 analyzes the customer account information of each active caller placed in the call queue for one or more common factors. In an embodiment, responsive to determining that the first threshold has been triggered, issue detection and resolution program 122 analyzes the customer account information of each active caller placed in the call queue for one or more common factors. In an embodiment, issue detection and resolution program 122 compares the overall makeup of the active callers placed in the call queue to the overall makeup of all the customers of the user. In an embodiment, issue detection and resolution program 122 compares the overall makeup of the active callers placed in the call queue to the overall makeup of all the customers of the user in order to determine the statistical significance of the one or more common factors (i.e., to determine whether the one or more common factors is likely due to chance or to some factor of interest). In an embodiment, issue detection and resolution program 122 identifies a reason for the event occurring from the one or more common factors.

In another embodiment, issue detection and resolution program 122 enables each active caller in the call queue to input a reason for calling the user. In an embodiment, issue detection and resolution program 122 performs a contextual analysis of the reason inputted by each active user in the call queue to identify key words used in the reason. In an embodiment, issue detection and resolution program 122 identifies a reason for the event occurring from the reason inputted by each active user in the call queue.

Continuing the second example from above, issue detection and resolution program 122 finds that a majority of the active callers placed in the call queue calling Airline Company D are from the Southwest of the United States, particularly from the Austin, Tex. area. Issue detection and resolution program 122 recognizes the central location (i.e., Austin, Tex. in the Southwest of the United States) as a common factor between the active callers in the call queue. Issue detection and resolution program 122 also finds that the jump in the number of active callers in the call queue came as Airline Company D started to cancel Airline Company D's morning flights from the Austin, Tex. airport in the Southwest of the United States. Issue detection and resolution program 122 recognizes the cancellation of the morning flights as another common factor between the active callers in the call queue.

In step 330, issue detection and resolution program 122 registers the event occurring as the domain event. In an embodiment, responsive to analyzing the customer account information of each active caller placed in the call queue for one or more common factors, issue detection and resolution program 122 registers the event occurring as the domain event. By registering the event occurring as the domain event, issue detection and resolution program 122 is acknowledging the event occurring as the event impacting a plurality of customers of the user and causing the plurality of customers to call the user for assistance.

Continuing the second example from above, issue detection and resolution program 122 registers the cancellation of Airline Company D's morning flights from the Austin, Tex. airport in the Southwest of the United States as a domain event impacting the plurality of customers of Airline Company D.

In step 335, issue detection and resolution program 122 processes a call for each active caller placed in the call queue using an artificial intelligence method. In an embodiment, responsive to registering the event occurring as the domain event, issue detection and resolution program 122 processes a call for each active caller placed in the call queue using an artificial intelligence method. In an embodiment, issue detection and resolution program 122 extracts a service response via NLP. In another embodiment, issue detection and resolution program 122 extracts a service response via a NLC. In another embodiment, issue detection and resolution program 122 extracts a service response via NLU.

In an embodiment, issue detection and resolution program 122 analyzes one or more previous customer service resolutions provided manually to one or more previous callers by a customer service representative for the same issue or similar issue as the event occurring (i.e., one or more customer service resolutions for one or more customers who had the same issue or similar issue, who contacted the user for assistance, and who received a successful resolution). In an embodiment, issue detection and resolution program 122 analyzes one or more previous customer service resolutions stored in a database, e.g., database 124.

In an embodiment, issue detection and resolution program 122 analyzes one or more previous customer service resolutions using natural language processing. In an embodiment, issue detection and resolution program 122 identifies one or more key words in the one or more previous customer service resolutions. In an embodiment, issue detection and resolution program 122 extracts the one or more key words from the one or more previous customer service resolutions. In an embodiment, issue detection and resolution program 122 extracts one or more words associated with the one or more key words from the one or more previous customer service resolutions (i.e., regarding the reason for the one or more previous customer service resolutions being provided and the one or more previous customer service resolutions). In an embodiment, issue detection and resolution program 122 stores the one or more key words and the one or more words associated with the one or more key words in the database, e.g., database 124.

In an embodiment, issue detection and resolution program 122 clusters the one or more key words and the one or more words associated with the one or more key words using k-means clustering. In an embodiment, issue detection and resolution program 122 clusters the one or more key words and the one or more words associated with the one or more key words using k-means clustering in order to find an underlying pattern in the one or more previous customer service resolutions. In an embodiment, issue detection and resolution program 122 matches a cluster created to a resolution (i.e., the reason for the resolution to the resolution). In an embodiment, issue detection and resolution program 122 matches a cluster created to a resolution using Robotic Process Automation (RPA). In another embodiment, issue detection and resolution program 122 matches a cluster created to a resolution using a neural network, in which the initial node is a cluster and the final node is a resolution. In an embodiment, issue detection and resolution program 122 minimizes the “loss function” based on historical data trends. In another embodiment, issue detection and resolution program 122 matches a cluster created to a resolution using an “If-then” statement (e.g., If “one or more key words” is detected, then “resolution A” is offered.). In an embodiment, issue detection and resolution program 122 selects a previous customer service resolution.

In another embodiment, issue detection and resolution program 122 compares the reason for the domain event occurring to the reason for the one or more previous customer service resolutions provided (i.e., to the one or more key words and the one or more words associated with the one or more key words extracted from the one or more previous customer service resolutions). In an embodiment, issue detection and resolution program 122 calculates a measure of similarity. The measure of similarity is defined as a vector. The measure of similarity is equal to a distance between the reason for the domain event occurring and the reason for the one or more previous customer service resolutions provided. In an embodiment, issue detection and resolution program 122 selects a previous customer service resolution that meets a pre-set threshold of similarity.

For example, in a previous customer service call, the customer service representative stated, “To summarize, your problem is . . . and our solution is . . . ” Issue detection and resolution program 122 extracts the key words “your problem” and “our solution” and the one or more words associated with the one or more key words. Issue detection and resolution program 122 stores the key words and the one or more words associated with the one or more key words in the database, e.g., database 124.

Continuing the first example from above, issue detection and resolution program 122 analyzes previous customer service resolutions and finds that, to resolve the previous customer service issues, the customer service representatives refunded the shipping fee since the delivery time frame was not met due to the carrier delay and offered a coupon for 20% off the active caller's next delivery.

Continuing the second example from above, issue detection and resolution program 122 enables the active caller placed in the call queue to input relevant information regarding the reason for calling the user. Issue detection and resolution program 122 processes the information input by the active caller using an artificial intelligence method. Issue detection and resolution program 122 also analyzes the issues of the first ten active callers who spoke with a customer service representative. Issue detection and resolution program 122 finds that the first ten active callers had similar issues that were resolved by the customer service representative in a similar manner. Issue detection and resolution program 122 finds that, to resolve the previous customer service issues, the customer service representatives rebooked the flight since the active caller's previously scheduled flight was cancelled.

In step 340, issue detection and resolution program 122 creates a resolution for each active caller placed in the call queue. In an embodiment, responsive to processing a call for each active user placed in the call queue using an artificial intelligence method, issue detection and resolution program 122 creates a resolution for each active caller placed in the call queue. In an embodiment, issue detection and resolution program 122 creates a resolution for each active caller placed in the call queue similar to the previous customer service resolution selected.

In an embodiment, issue detection and resolution program 122 pre-generates an Interactive Voice Response (IVR) workflow (i.e., on the IVR system). In an embodiment, issue detection and resolution program 122 pre-generates an IVR workflow based on the resolution created. In an embodiment, issue detection and resolution program 122 dynamically modifies the IVR system to incorporate the IVR workflow pre-generated as a learned response for similar situations.

In an embodiment, issue detection and resolution program 122 generates a synthesized voice message customized for each active caller placed in the call queue. In an embodiment, issue detection and resolution program 122 generates a synthesized voice message acknowledging the event occurring and offering the resolution. In an embodiment, issue detection and resolution program 122 plays the synthesized voice message for each active caller placed in the call queue.

In an embodiment, issue detection and resolution program 122 enables each active caller placed in the call queue to accept the resolution.

Continuing the first example from above, issue detection and resolution program 122 generates a synthesized voice message that states, “Thank you for calling Delivery Company A, Mr. Smith. We have detected that multiple customers in your area are calling about a delivery delay to the packages that were supposed to be delivered by 10:30 A.M. this morning. The severe weather occurring in the Northeast area of the United States caused staffing fluctuations. Due to those staffing fluctuations, the delivery of the overnight packages was delayed. As a resolution for our valued customers, we would like to offer you a full refund of the shipping fee for the above delivery and a coupon for 20% off your next delivery with Delivery Company A. Please press 1 if you would like to accept this resolution. Please press 2 if you would like to remain on hold for the next customer service representative.”

Continuing the second example from above, issue detection and resolution program 122 generates a synthesized voice message that states, “Thank you for calling Airline Company D. We believe you had a previously scheduled flight out of the Austin, Tex. airport that was cancelled. As a resolution for our valued customers, we would like to rebook your flight for the next available flight. Please press 1 if you would like to accept this resolution. Please press 2 if you would like to remain on hold for the customer service representative.”

In decision 345, issue detection and resolution program 122 determines whether a second threshold is triggered. In an embodiment, responsive to creating a resolution, issue detection and resolution program 122 determines whether a second threshold is triggered. In an embodiment, issue detection and resolution program 122 enables the user to pre-set the second threshold to be triggered when a number or a percentage of active callers accept the resolution. In an embodiment, issue detection and resolution program 122 enables the user to dynamically resize the number or the percentage of active callers at run time (i.e., automatically resize the number or the percentage of active callers) to determine which active callers have access to the pre-generated IVR workflow. In another embodiment, issue detection and resolution program 122 enables the user to pre-set the second threshold to be triggered based on one or more priority levels (i.e., based on a level of urgency of the event occurring). For example, the second threshold is pre-set to be triggered at a low priority level (i.e. insignificant requests would need a low acceptance rate or threshold in order for the IVR workflow to be executed), a medium priority level (i.e., minor requests would need a solid acceptance rate or threshold in order for the IVR workflow to be executed), and a high priority level (i.e., major requests would need manager approval and/or interaction or a high acceptance rate or threshold in order for the IVR workflow to be executed).

If issue detection and resolution program 122 determines the second threshold is triggered (decision 345, YES branch), then issue detection and resolution program 122 proceeds to step 350, executing the IVR workflow. If issue detection and resolution program 122 determines the second threshold is not triggered (decision 345, NO branch), issue detection and resolution program 122 returns to step 340, creating a resolution.

In step 350, issue detection and resolution program 122 executes the IVR workflow. In an embodiment, responsive to determining a second threshold is triggered, issue detection and resolution program 122 executes the IVR workflow. In an embodiment, issue detection and resolution program 122 stores the IVR workflow in a database, e.g., database 124.

Continuing the second example from above, responsive to the active caller pressing 1 to accept the resolution offered, issue detection and resolution program 122 executes the IVR workflow. Once the IVR workflow is executed, issue detection and resolution program 122 includes in the synthesized voice message the flight number of the flight on which the active caller was rebooked.

In step 355, issue detection and resolution program 122 requests feedback on the IVR workflow from the user. In an embodiment, responsive to executing the IVR workflow, issue detection and resolution program 122 requests feedback on the IVR workflow from the user. In an embodiment, issue detection and resolution program 122 provides a summary with the request for feedback on the IVR workflow. In an embodiment, issue detection and resolution program 122 provides a summary of the calls of each active caller placed in the call queue processed using an artificial intelligence method and the resolution provided to each active caller.

In an embodiment, issue detection and resolution program 122 receives feedback on the IVR workflow from the user. In an embodiment, issue detection and resolution program 122 receives feedback on the resolution provided to each active caller from the user (e.g., agreement or disagreement with the resolution provided).

In an embodiment, issue detection and resolution program 122 processes the feedback received on the IVR workflow. In an embodiment, issue detection and resolution program 122 gauges the relevancy of the feedback received on the IVR workflow from the user. In an embodiment, issue detection and resolution program 122 applies the feedback on the IVR workflow gauged as relevant. In an embodiment, issue detection and resolution program 122 stores the feedback received from the user in a database, e.g., database 124.

FIG. 4 is a block diagram illustrating the components of computing device 400 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made. Computing device 400 includes processor(s) 404, memory 406, cache 416, communications fabric 402, persistent storage 408, input/output (I/O) interface(s) 412, and communications unit 410. Communications fabric 402 provides communications between memory 406, cache 416, persistent storage 408, input/output (I/O) interface(s) 412, and communications unit 410. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a cross switch. Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Program instructions and data (e.g., software and data) used to practice embodiments of the present invention may be stored in persistent storage 408 and in memory 406 for execution by one or more of the respective processor(s) 404 via cache 416. In an embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408. Software and data can be stored in persistent storage 408 for access and/or execution by one or more of the respective processor(s) 404 via cache 416. With respect to user computing device 130, software and data includes user interface 132. With respect to server 120, software and data includes issue detection and resolution program 122.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data (e.g., software and data) used to practice embodiments of the present invention may be downloaded to persistent storage 408 through communications unit 410.

I/O interface(s) 412 allows for input and output of data with other devices that may be connected to each computer system. For example, I/O interface(s) 412 may provide a connection to external device(s) 418, such as a keyboard, a keypad, a touch screen, and/or some other suitable input device. External device(s) 418 can also include portable computer readable storage media, such as, for example, thumb drives, portable optical or magnetic disks, and memory cards. Program instructions and data (e.g., software and data) used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

While particular embodiments of the present invention have been shown and described here, it will be understood to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understand, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “at least one” or “one or more” and indefinite articles such as “a” or “an”, the same holds true for the use in the claims of definite articles.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each flowchart illustration and/or block of the block diagrams, and combinations of flowchart illustration and/or blocks in the block diagrams, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
responsive to an event occurring that impacts a plurality of customers of a user and causes the plurality of customers to call the user for assistance, determining, by one or more processors, if there is a domain event registered for the event occurring;
responsive to determining the domain event is not registered for the event occurring, monitoring, by the one or more processors, a call queue of the plurality of customers calling the user;
determining, by the one or more processors, that a first threshold is triggered, wherein the first threshold is triggered when a pre-set percentage of active callers are placed in the call queue;
analyzing, by the one or more processors, a set of information in a customer account of each active caller placed in the call queue for one or more common factors;
identifying, by the one or more processors, a reason for the event occurring from the one or more common factors;
registering, by the one or more processors, the event occurring as the domain event;
processing, by the one or more processors, a call for each active caller placed in the call queue using an artificial intelligence method;
resolving, by the one or more processors, the event occurring by providing the plurality of customers calling the user with a resolution;
determining, by the one or more processors, if a second threshold is triggered, wherein the second threshold is triggered when a pre-set percentage of active callers accept the resolution; and
responsive to determining the second threshold is triggered, executing, by the one or more processors, an Interactive Voice Response (IVR) workflow.

2. The computer-implemented method of claim 1, further comprising:
prior to determining if the domain event is registered for the event occurring, identifying, by the one or more processors, each active caller placed in the call queue, wherein each active caller placed in the call queue is identified by doing a reverse search of a phone number from which each active caller in the call queue called.

3. The computer-implemented method of claim 1, further comprising:
subsequent to executing the IVR workflow, requesting, by the one or more processors, feedback on the IVR workflow from the user;
receiving, by the one or more processors, the feedback on the IVR workflow from the user;
gauging, by the one or more processors, a level of relevancy of the feedback on the IVR workflow; and
applying, by the one or more processors, the feedback on the IVR workflow.

4. The computer-implemented method of claim 1, further comprising:
responsive to determining the domain event is registered for the event occurring, analyzing, by the one or more processors, the set of information in the customer account of each active caller placed in the call queue for the one or more common factors;
creating, by the one or more processors, one or more clusters that are each representative of the one or more common factors; and
segmenting, by the one or more processors, the active callers in the call queue into the one or more clusters.

5. The computer-implemented method of claim 1, wherein processing the call for each active caller placed in the call queue using the artificial intelligence method further comprises:
extracting, by the one or more processors, a service response via Natural Language Processing;
extracting, by the one or more processors, a service response via Natural Language Classifier; or
extracting, by the one or more processors, a service response via Natural Language Understanding.

6. The computer-implemented method of claim 1, wherein processing the call for each active caller placed in the call queue using the artificial intelligence method further comprises:
analyzing, by the one or more processors, one or more resolutions provided manually to one or more previous callers by one or more customer service representatives for an issue identical to or nearly identical to the event occurring;
identifying, by the one or more processors, one or more key words in the one or more resolutions provided manually to the one or more previous callers;
extracting, by the one or more processors, the one or more key words and one or more words associated with the one or more key words from the one or more resolutions provided manually to the one or more previous callers; and
modifying, by the one or more processors, dynamically an IVR system to incorporate a learned response, wherein the learned response is the one or more resolutions provided manually to the one or more previous callers.

7. The computer-implemented method of claim 1, wherein resolving the event occurring by providing the plurality of customers calling the user with the resolution further comprises:
pre-generating, by the one or more processors, the IVR workflow based on the learned response;
generating, by the one or more processors, a synthesized voice message customized for each active caller placed in the call queue acknowledging the event occurring and offering the resolution;
playing, by the one or more processors, the synthesized voice message for each active caller placed in the call queue; and
enabling, by the one or more processors, each active caller placed in the call queue to accept the resolution.

8. The computer-implemented method of claim 1, wherein the second threshold is pre-set to one or more priority levels based on a level of urgency of the event occurring.

9. A computer program product comprising:
one or more computer readable storage media and program instructions stored on the one or more computer readable storage media, the program instructions comprising:
responsive to an event occurring that impacts a plurality of customers of a user and causes the plurality of customers to call the user for assistance, program instructions to determine if there is a domain event registered for the event occurring;
responsive to determining the domain event is not registered for the event occurring, program instructions to monitor a call queue of the plurality of customers calling the user;
program instructions to determine that a first threshold is triggered, wherein the first threshold is triggered when a pre-set percentage of active callers are placed in the call queue;
program instructions to analyze a set of information in a customer account of each active caller placed in the call queue for one or more common factors;
program instructions to identify a reason for the event occurring from the one or more common factors;
program instructions to register the event occurring as the domain event;
program instructions to process a call for each active caller placed in the call queue using an artificial intelligence method;
program instructions to resolve the event occurring by providing the plurality of customers calling the user with a resolution;
program instructions to determine if a second threshold is triggered, wherein the second threshold is triggered when a pre-set percentage of active callers accept the resolution; and
responsive to determining the second threshold is triggered, program instructions to execute an Interactive Voice Response (IVR) workflow.

10. The computer program product of claim 9, further comprising:
subsequent to executing the IVR workflow, program instructions to request feedback on the IVR workflow from the user;
program instructions to receive the feedback on the IVR workflow from the user;
program instructions to gauge a level of relevancy of the feedback on the IVR workflow; and
program instructions to apply the feedback on the IVR workflow.

11. The computer program product of claim 9, further comprising:
responsive to determining the domain event is registered for the event occurring, program instructions to analyze the set of information in the customer account of each active caller placed in the call queue for the one or more common factors;
program instructions to create one or more clusters that are each representative of the one or more common factors; and
program instructions to segment the active callers in the call queue into the one or more clusters.

12. The computer program product of claim 9, wherein processing the call for each active caller placed in the call queue using the artificial intelligence method further comprises:
program instructions to extract a service response via Natural Language Processing;
program instructions to extract a service response via Natural Language Classifier; or
program instructions to extract a service response via Natural Language Understanding.

13. The computer program product of claim 9, wherein processing the call for each active caller placed in the call queue using the artificial intelligence method further comprises:
program instructions to analyze one or more resolutions provided manually to one or more previous callers by one or more customer service representatives for an issue identical to or nearly identical to the event occurring;
program instructions to identify one or more key words in the one or more resolutions provided manually to the one or more previous callers;
program instructions to extract the one or more key words and one or more words associated with the one or more key words from the one or more resolutions provided manually to the one or more previous callers; and
program instructions to modify dynamically an IVR system to incorporate a learned response.

14. The computer program product of claim 9, wherein resolving the event occurring by providing the plurality of customers calling the user with the resolution further comprises:
program instructions to pre-generating the IVR workflow based on the learned response;
program instructions to generate a synthesized voice message customized for each active caller placed in the call queue acknowledging the event occurring and offering the resolution;
program instructions to play the synthesized voice message for each active caller placed in the call queue; and
program instructions to enable each active caller placed in the call queue to accept the resolution.

15. A computer system comprising:
one or more computer processors;
one or more computer readable storage media;
program instructions collectively stored on the one or more computer readable storage media for execution by at least one of the one or more computer processors, the stored program instructions comprising:
responsive to an event occurring that impacts a plurality of customers of a user and causes the plurality of customers to call the user for assistance, program instructions to determine if there is a domain event registered for the event occurring;
responsive to determining the domain event is not registered for the event occurring, program instructions to monitor a call queue of the plurality of customers calling the user;
program instructions to determine that a first threshold is triggered, wherein the first threshold is triggered when a pre-set percentage of active callers are placed in the call queue;
program instructions to analyze a set of information in a customer account of each active caller placed in the call queue for one or more common factors;
program instructions to identify a reason for the event occurring from the one or more common factors;
program instructions to register the event occurring as the domain event;
program instructions to process a call for each active caller placed in the call queue using an artificial intelligence method;
program instructions to resolve the event occurring by providing the plurality of customers calling the user with a resolution;
program instructions to determine if a second threshold is triggered, wherein the second threshold is triggered when a pre-set percentage of active callers accept the resolution; and
responsive to determining the second threshold is triggered, program instructions to execute an Interactive Voice Response (IVR) workflow.

16. The computer system of claim 15, further comprising:
subsequent to executing the IVR workflow, program instructions to request feedback on the IVR workflow from the user;
program instructions to receive the feedback on the IVR workflow from the user;
program instructions to gauge a level of relevancy of the feedback on the IVR workflow; and
program instructions to apply the feedback on the IVR workflow.

17. The computer system of claim 15, further comprising:
responsive to determining the domain event is registered for the event occurring, program instructions to analyze the set of information in the customer account of each active caller placed in the call queue for the one or more common factors;
program instructions to create one or more clusters that are each representative of the one or more common factors; and
program instructions to segment the active callers in the call queue into the one or more clusters.

18. The computer system of claim 15, wherein processing the call for each active caller placed in the call queue using the artificial intelligence method further comprises:
program instructions to extract a service response via Natural Language Processing;
program instructions to extract a service response via Natural Language Classifier; or
program instructions to extract a service response via Natural Language Understanding.

19. The computer system of claim 15, wherein processing the call for each active caller placed in the call queue using the artificial intelligence method further comprises:
program instructions to analyze one or more resolutions provided manually to one or more previous callers by one or more customer service representatives for an issue identical to or nearly identical to the event occurring;
program instructions to identify one or more key words in the one or more resolutions provided manually to the one or more previous callers;
program instructions to extract the one or more key words and one or more words associated with the one or more key words from the one or more resolutions provided manually to the one or more previous callers; and
program instructions to modify dynamically an IVR system to incorporate a learned response.

20. The computer system of claim 15, wherein resolving the event occurring by providing the plurality of customers calling the user with the resolution further comprises:
program instructions to pre-generating the IVR workflow based on the learned response;
program instructions to generate a synthesized voice message customized for each active caller placed in the call queue acknowledging the event occurring and offering the resolution;
program instructions to play the synthesized voice message for each active caller placed in the call queue; and
program instructions to enable each active caller placed in the call queue to accept the resolution.
